(19) United States
(12) Patent Application Publication
(10) Pub. No.: US 2014/0252746 A1
(43) Pub. Date: Sep. 11, 2014

(54) BICYCLE ELECTRONIC DISPLAY AND SHIFT LEVER MOUNT

(71) Applicant: SPECIALIZED BICYCLE COMPONENTS, INC., Morgan Hill, CA (US)

(72) Inventors: Jan Talavasek, Knonau (CH); Holger Krauss, Menzingen (CH)

(73) Assignee: SPECIALIZED BICYCLE COMPONENTS, INC., Morgan Hill, CA (US)

(21) Appl. No.: 13/787,352

(22) Filed: Mar. 6, 2013

(51) Int. Cl. B62K 21/12

(52) U.S. Cl. CPC B62K 21/12
USPC 280/288.4

(57) ABSTRACT

A bicycle comprising front and rear wheels, a bicycle frame and front fork supported on the front and rear wheel, a handlebar coupled to the front fork, and a component mounting assembly. The component mounting assembly includes a base coupled to the handlebar, a first component (e.g., an electronic display) supported by the base, and a second component (e.g., a gear shift lever) supported by the base. The base can comprise a clamp member of a brake lever assembly, and a position of the base can be rotationally adjustable relative to the handlebar. In one embodiment, the base includes a curved mounting surface (e.g., a cylindrical surface) that supports the second component and facilitates adjustment of a position of the second component relative to the base. The base can further include an elongated opening through which a fastener is positioned to secure the second component to the base.

### BACKGROUND

The present invention relates generally to the field of bicycles and specifically to systems for mounting bicycle components, such as electronic displays and shift levers to a bicycle.

Many bicycles include components or accessories that provide a variety of functions. For example, some bicycles include gear shift levers that facilitate changing gears. Other bicycles include an electronic display for providing information regarding the operation of the bicycle, such as speed, cadence, and power output. On bicycles with electric drives, the display can provide information regarding the status of the drive system, such as battery life or amount of motor assist.

Components and accessories can be mounted on the bicycle in a variety of different ways and locations. For example, shift levers have been mounted on the bicycle frame, handlebars, or handlebar stem using a clamp or using a mount permanently secured (e.g., welded, braked, or bonded) to the bicycle. Electronic displays are commonly clamped to the handlebars.

Due to the limited real estate available on a bicycle, it would be beneficial to provide alternate ways to mount components to a bicycle.

### SUMMARY

The present invention provides a bicycle comprising front and rear wheels, a bicycle frame and front fork supported on the front and rear wheel, a handlebar coupled to the front fork, and a component mounting assembly. The component mounting assembly includes a base coupled to the handlebar, a first component (e.g., an electronic display) supported by the base, and a second component (e.g., a gear shift lever) supported by the base. The base can comprise a clamp member of a brake lever assembly, and a position of the base can be rotationally adjustable relative to the handlebar.

In one embodiment, the base includes a curved mounting surface (e.g., a cylindrical surface) that supports the second component and facilitates adjustment of a position of the second component relative to the base. The base can further include an elongated opening through which a fastener is positioned to secure the second component to the base.

The present invention is also embodied in a bicycle mounting assembly including a base adapted to be coupled to a handlebar, an electronic display supported by the base, and a gear shift lever supported by the base. A position of the gear shift lever relative to the display can be adjustable to thereby facilitate adjustment of the position of the gear shift lever without changing the position of the display relative to the handlebar. As with the previous aspect of the invention, the base can include a curved mounting surface (e.g., a cylindrically-shaped surface) that supports the gear shift lever and facilitates adjustment of a position of the gear shift lever relative to the base. The base can also include an elongated opening through which a fastener is positioned to secure the gear shift lever to the base.

Other aspects of the invention will become apparent by consideration of the detailed description and accompanying drawings.

### BRIEF DESCRIPTION OF THE DRAWINGS

FIG. 1 is a side view of a bicycle including a bicycle component mount embodying the present invention.

FIG. 2 is an enlarged perspective view a portion of the bicycle, including the component mount and handlebar.

FIG. 3 is a rear view of the structure in FIG. 2.

FIG. 4 is an exploded perspective view of the structure in FIG. 2.

FIG. 5 is a section view taken along line 5-5 in FIG. 3.

FIG. 6 is a perspective view of an electronic controller from the embodiment of FIG. 2.

FIG. 7 is an exploded bottom view of part of the structure of FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

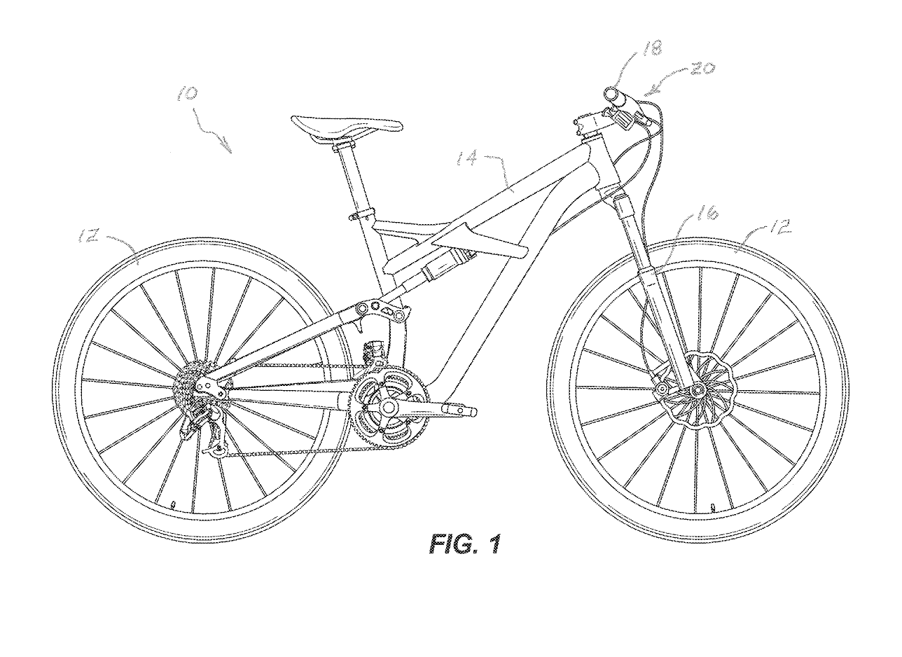

FIG. 1 illustrates a bicycle 10 having front and rear wheels 12, a bicycle frame 14 and a front fork 16 supported on the wheels 12, a handlebar 18 coupled to the front fork 16, and a brake lever assembly 20 that facilitates braking the bicycle 10.

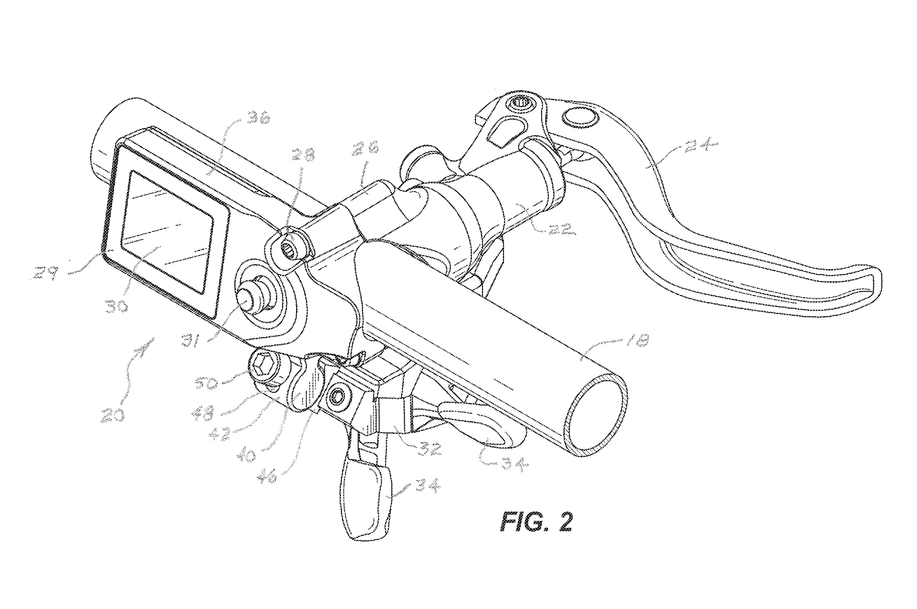

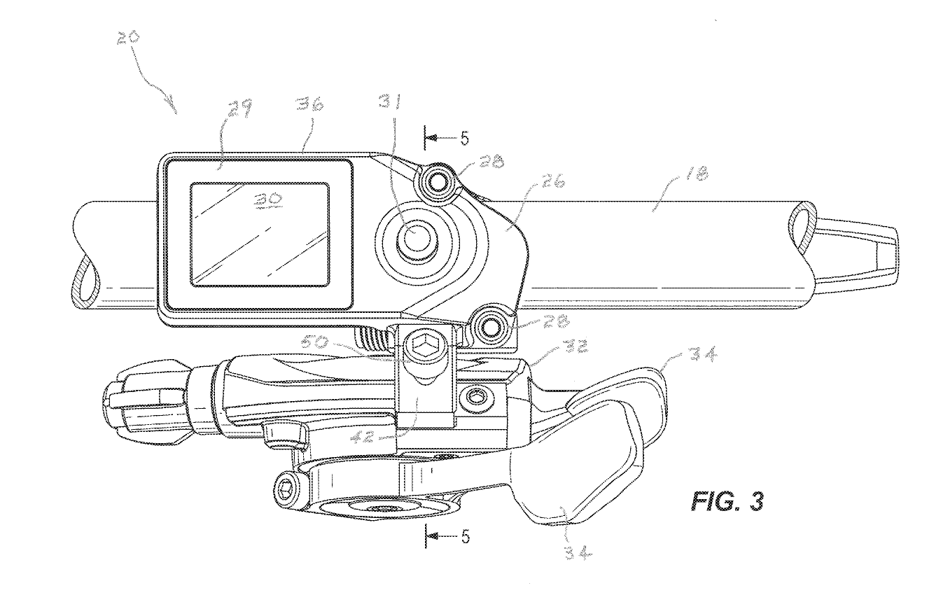

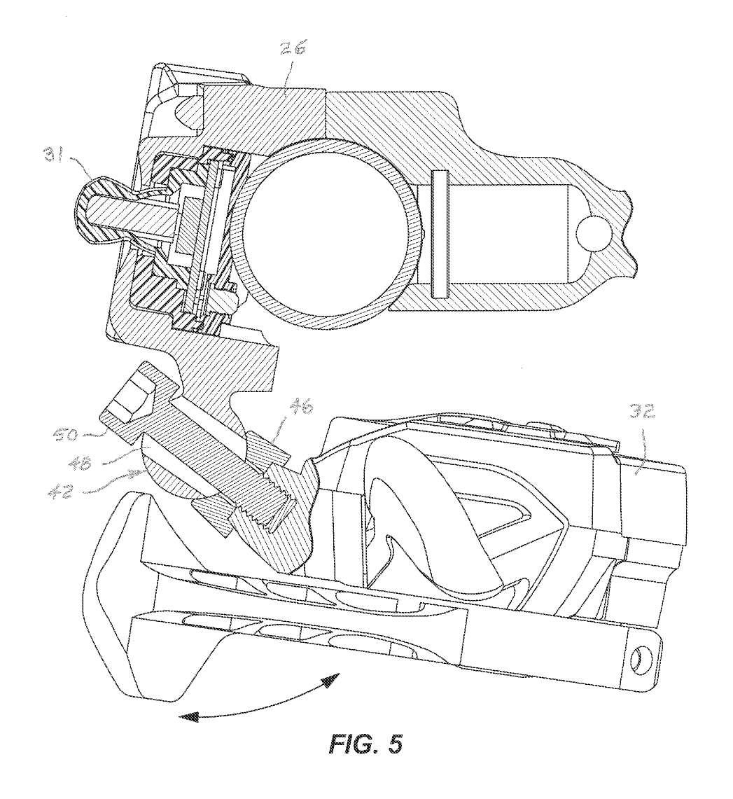

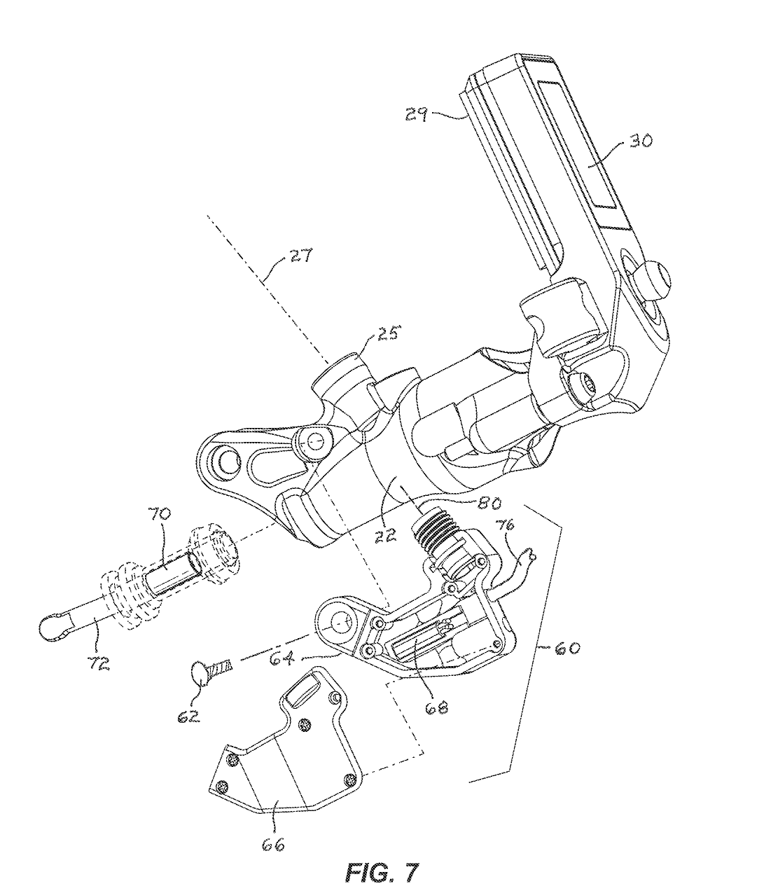

Referring to FIGS. 2-5, the brake lever assembly 20 includes a brake body 22, a brake lever 24 pivotally supported by the brake body 22, and a clamp member 26 cooperating with the housing 22 to clamp the brake lever assembly 20 to the handlebar 18 using two clamp fasteners 28. Referring to FIG. 7, the brake body 22 includes a hydraulic connector 25 defining a hydraulic axis 27. The position of the brake lever assembly 20 relative to the handlebar 18 can be adjusted by loosening the two clamp fasteners 28, rotating the brake lever assembly 20 relative to the handlebar 18, and re-tightening the clamp fasteners 28. In the illustrated embodiment, the clamp member 26 acts as a base to support one or more bicycle components. More specifically, the illustrated clamp member 26 supports an electronic controller 29 (having a display 30 and joystick 31) and a shifting assembly 32 (having a shift lever 34).

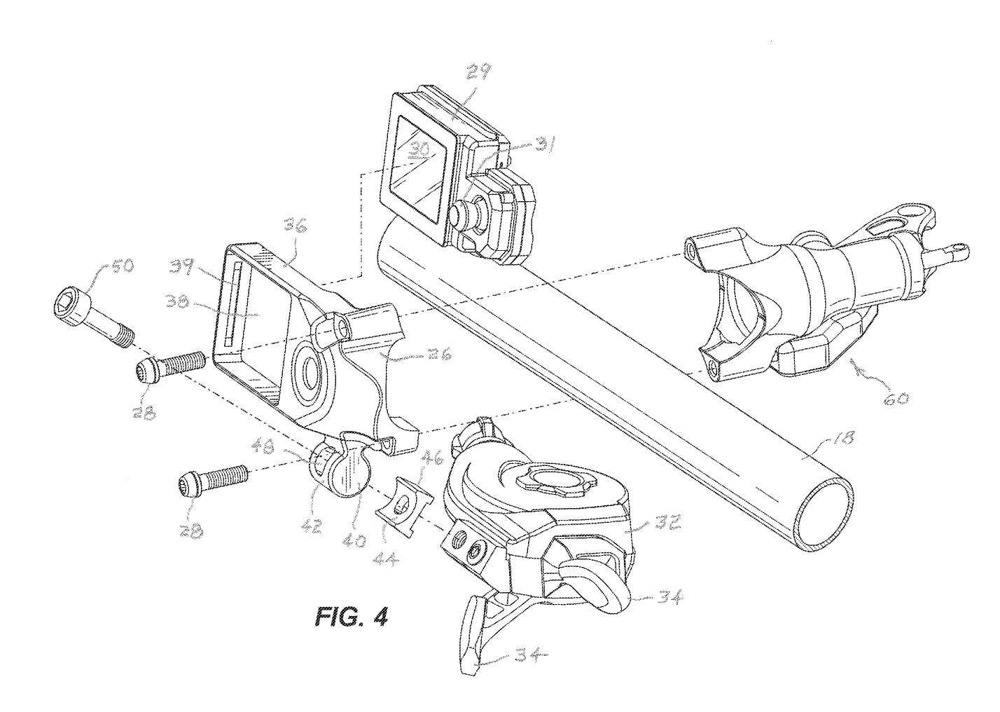

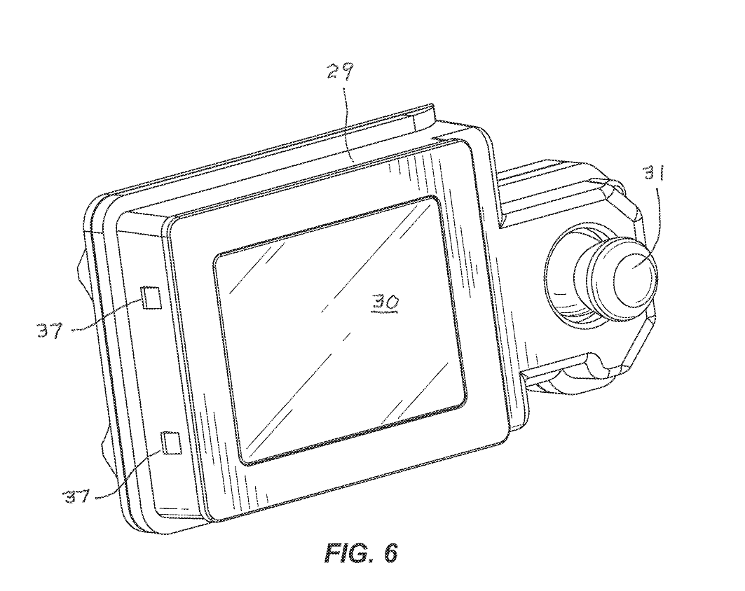

The display 30 and certain vehicle operations can be controlled by manipulation of the joystick 31 by the user's thumb. A variety of parameters, such as eBike functions, menu, light, shifting, suspension, seat post height, power meter, vehicle speed, cadence, heartrate, battery life, or bell, can be shown on the display 30 and/or operated by the joystick. The electronic controller 29 is supported by a first mounting portion 36 of the clamp member 26. The first mounting portion 36 includes a rectangular opening 38 that facilitates viewing the display 30 when the display 30 is secured to the first mounting portion 36. In the illustrated embodiment, the electronic controller 29 includes detents 37 that snap into a recess 39 in the first mounting portion 36 (see FIGS. 4 and 6). Alternatively, the electronic controller 29 can be secured to the first mounting portion 36 and any suitable manner, such as using fasteners.

The shifting assembly 32 is supported by a second mounting portion 40 of the clamp member 26. The second mounting portion 40 includes a convex cylindrical surface 42, and the shifting assembly 32 includes a corresponding concave cylindrical surface 44 (present in a washer 46 in the illustrated embodiment) that receives the convex cylindrical 42 surface of the second mounting portion 40. The second mounting portion 40 of the clamp member 26 further includes an elongated opening 48. A mounting fastener 50 is positioned through the elongated opening 48 to secure the shifting assembly 32 to the second mounting portion 40. The above-described cylindrical surfaces 42, 44 and elongated opening 48 cooperate to facilitate rotational adjustment of the shifting assembly 32 relative to the clamp member 26 and relative to the electronic display 30.

By utilizing the clamp member 26 of the brake lever assembly 20 to support the electronic display 30 and the shifting assembly 32, the space required to clamp the multiple components to the handlebar 18 is significantly reduced. In addition, due to the configuration of the second mounting portion 40, the position of the shift lever 34 relative to the rider and relative to the electronic display 30 can be adjusted without the need to adjust the position of the brake lever assembly 20 relative to the handlebar 18.

Referring to FIG. 7, the brake lever assembly 20 further includes a brake switch assembly 60 secured to a bottom surface of the brake body 22 by a fastener 62. The switch assembly 60 senses actuation of the brake and includes a switch housing 64, a switch cover 66, and a reed switch 68 housed within the switch housing 64. The reed switch 68 senses movement of a magnet 70 positioned inside a brake piston 72 that moves within the brake body 22. An electronic connector 74 is coupled to the switch housing 64 and provides a location for outputting an electronic signal from the switch assembly 60 to a remote controller (e.g., a central processor), and a cable 76 provides an electrical connection between the switch assembly 60 and the electronic controller 29 and display 30. The electronic connector 74 extends from the switch housing 64 along an electronic output axis 80 that is substantially parallel to the hydraulic axis 27.

Various features of the invention are set forth in the following claims.

1. A bicycle comprising:
front and rear wheels;
a bicycle frame supported on the front and rear wheels;
a front fork supported by the front wheel and coupled to the bicycle frame;
a handlebar coupled to the front fork; and
a mounting assembly including:
a base coupled to the handlebar;
a first component supported by the base; and
a second component supported by the base.

2. A bicycle as claimed in claim 1, further comprising a brake lever assembly coupled to the handlebar, wherein the base and the brake lever assembly are coupled together to clamp the handlebar in between.

3. A bicycle as claimed in claim 2, wherein the brake lever assembly and base are rotationally adjustable relative to the handlebar.

4. A bicycle as claimed in claim 1, wherein the first component comprises an electronic display.

5. A bicycle as claimed in claim 4, wherein the second component comprises a gear shift lever.

6. A bicycle as claimed in claim 5, wherein a position of the gear shift lever relative to the display is adjustable.

7. A bicycle as claimed in claim 1, wherein the base includes a curved mounting surface that supports the second component and facilitates adjustment of a position of the second component relative to the base.

8. A bicycle as claimed in claim 7, wherein the curved mounting surface comprises a cylindrically-shaped surface.

9. A bicycle as claimed in claim 7, wherein the base further has an elongated opening, and wherein the mounting assembly further includes a fastener positioned in the elongated opening to secure the second component to the base.

10. A bicycle comprising:
front and rear wheels;
a bicycle frame supported on the front and rear wheels;
a front fork supported by the front wheel and coupled to the frame;
a handlebar coupled to the front fork;
a brake lever assembly coupled to the handlebar and including:
a housing;
a brake lever pivotally supported by the housing; and
a clamp member cooperating with the housing to clamp the handlebar in between; and
a bicycle component supported by the clamp member.

11. A bicycle as claimed in claim 10, wherein the bicycle component comprises an electronic display.

12. A bicycle as claimed in claim 10, wherein the bicycle component comprises a gear shift lever.

13. A bicycle as claimed in claim 10, wherein a position of the bicycle component relative to clamp member is adjustable.

14. A bicycle as claimed in claim 10, wherein the clamp member includes a curved mounting surface that supports the bicycle component and facilitates adjustment of a position of the bicycle component relative to the clamp member.

15. A bicycle as claimed in claim 14, wherein the curved mounting surface comprises a cylindrically-shaped surface.

16. A bicycle mounting assembly including:
a base adapted to be coupled to a handlebar;
an electronic display supported by the base; and
a gear shift lever supported by the base.

17. A bicycle mounting assembly as claimed in claim 16, wherein a position of the gear shift lever relative to the display is adjustable.

18. A bicycle mounting assembly as claimed in claim 16, wherein the base includes a curved mounting surface that supports the gear shift lever and facilitates adjustment of a position of the gear shift lever relative to the base.

19. A bicycle mounting assembly as claimed in claim 18, wherein the curved mounting surface comprises a cylindrically-shaped surface.

20. A bicycle mounting assembly as claimed in claim 16, wherein the base includes an elongated opening, and wherein the mounting assembly further includes a fastener positioned in the elongated opening to secure the gear shift lever to the base.
